(19) United States
(12) Patent Application Publication
(10) Pub. No.: US 2017/0249970 A1
(43) Pub. Date: Aug. 31, 2017

(54) CREATING REALTIME ANNOTATIONS FOR VIDEO

(71) Applicant: LinkedIn Corporation, Mountain View, CA (US)

(72) Inventors: Sivakumar Loganathan, Sunnyvale, CA (US); Deepak Ponraj, Fremont, CA (US); Puneet Sethi, Santa Clara, CA (US)

(21) Appl. No.: 15/053,909

(22) Filed: Feb. 25, 2016

(51) Int. Cl. G11B 27/031; G06F 3/0484

(52) U.S. Cl. CPC G11B 27/031; G06F 3/04845; G06F 3/04847

(57) ABSTRACT

Techniques are provided for creating annotations of user input. In one technique, user input is received on a screen while a video is being played. The user input corresponds to a period of time that includes a first time and a second time. While the user input is received, a first snapshot is generated of the user input and a second snapshot is generated for the user input. The first snapshot corresponds to the first time and the second snapshot corresponds to the second time. A first annotation that identifies the first time is created based on the first snapshot. A second annotation that identifies the second time is created based on the second snapshot. Each snapshot is stored in association with the video.

### RELATED CASE

This application is related to U.S. patent application Ser. No. 15/040,292, filed on Feb. 10, 2016, which is incorporated herein by reference as if fully disclosed herein.

### TECHNICAL FIELD

The present disclosure relates to data processing and, more specifically, to recording user input while video data is displayed.

### BACKGROUND

The Internet has allowed people from across the globe to view videos, regardless of whether the videos are produced by a large motion picture company or a teenager in Africa. User interaction with video tends to be limited to viewing the video and, if the video platform through which the video is provided so allows, sharing the video with friends and/or creating text comments about the video.

However, viewers of video (including creators/authors of the video) are typically unable to modify the video unless they have access to video modification software, which may be expensive. For example, a user that is viewing an educational lecture online identifies a portion of the lecture or accompanying visual presentation as important. The user may record in his/her personal notes (whether physical notes or electronic notes) when that portion occurred so that the user may (a) view that portion later and/or (b) indicate to fellow classmates which portion the user deemed most important. However, such a record is manual and relatively labor intensive, requiring the user to describe the important subject matter, record when the important subject matter was presented, and later recall that notes were taken at all. If the user forgets that s/he had taken notes or misplaces the notes altogether, then the time and effort to produce the notes is wasted.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 is a block diagram that depicts an example system for providing video data and annotations, in an embodiment;

FIG. 2 is a block diagram that depicts example elements provided by a video player, in an embodiment;

FIG. 3 is a flow diagram that depicts a process for creating an annotation to video data, in an embodiment;

FIGS. 4A-4C are block diagrams that depict multiple snapshots of user input, in an embodiment;

FIG. 5 is a block diagram that illustrates a computer system upon which an embodiment of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

A system and method for creating annotations and associating the annotations with video data is described herein. In one technique, while a portion of the video data is displayed on a screen of a computing device, a user provides input at a point in a timeline of the video data. An annotation is created in response to receiving the input. The annotation is stored in association with the point in the timeline. Later, when the video data is displayed or played on the same or different computing device, the annotation is presented at that point in the timeline of the video data.

### System Overview

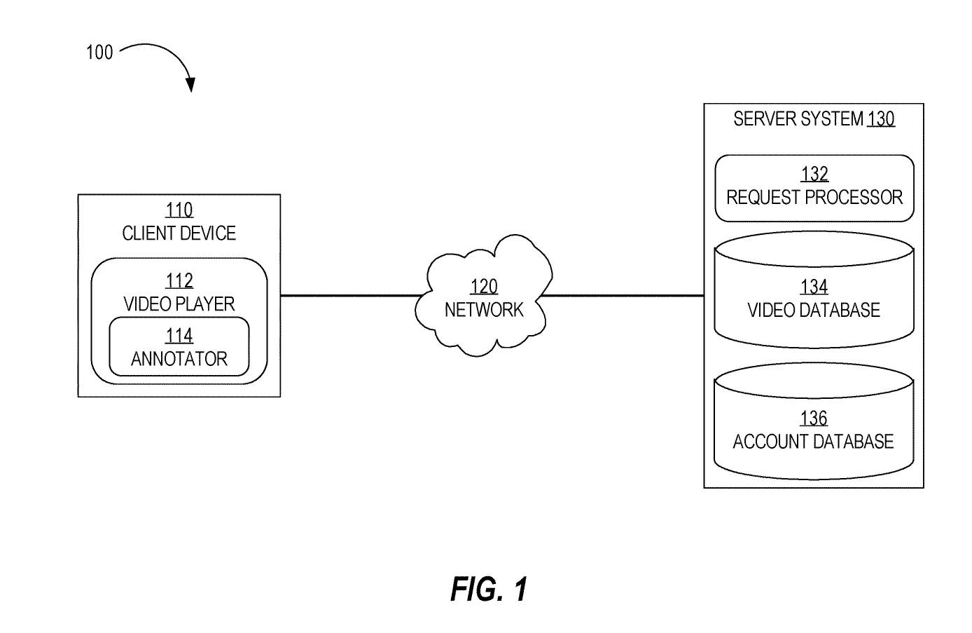

FIG. 1 is a block diagram that depicts a system 100 for providing video data and annotations, in an embodiment. System 100 comprises client device 110, network 120, and server system 130. While only one client device is depicted, system 100 may include many client devices that are communicatively coupled to server system 130 over network 120.

Examples of client device 110 include a laptop computer, a tablet computer, a desktop computer, and a smartphone. Client device 110 may include many applications and capabilities that are unrelated to video playing, such as a contacts manager, a web browser, a camera, games, a word processor, a flashlight, etc.

Client device 110 includes a video player 112 that plays video by causing multiple video frames (rendered from video data) to be displayed on a screen of client device 110. Video player 112 may be an application that executes on client device 110 as a stand-alone application. Alternatively, video player 112 executes within a web browser (or another application executing on client device 110) that is used to connect to server system 130. Alternatively, video player 112 is embedded within an application (e.g., a “mobile” application). In either scenario, video player 112 may read video data (that is stored locally) from one or more video files or receive and play streaming video data from a remote source (e.g., server system 130).

Video player 112 may be able to process video data that is in only one video file format file or video data that is in multiple file formats. Example file formats include.wmv, .avi, .mov, or .webm formats.

Subsequent references to “video player 112” may include an application that includes multiple software components, among which is a video player component that is configured to process video data and display video.

Video player 112 includes controls to play, stop, pause, rewind, and/or forward video, and, optionally, playback speed (e.g., 1.5× or 2×). The controls may also include controls to adjust parameters, such as brightness and contrast of the displayed video. The controls may also include controls to adjust volume of audio that is played concurrently with the video. While examples provided herein are in the context of video, some embodiments may be limited to just audio, where annotations are stored in association with an audio file and presented at certain points during audio playback.

Video player 112 includes an annotator 114 that creates annotations based on user input received through an interface of client device 110, such as a touchscreen of client device 110, a mouse that is connected to client device 110, or a microphone that detects audio and that is embedded in, or connected to, client device 110.

Network 120 may be implemented on any medium or mechanism that provides for the exchange of data between client device 110 and server system 130. Examples of network 120 include, without limitation, a network such as a Local Area Network (LAN), Wide Area Network (WAN), Ethernet or the Internet, or one or more terrestrial, satellite or wireless links.

### Server System

Although depicted as a single element, server system 130 may comprise multiple computing elements and devices, connected in a local network or distributed regionally or globally across many networks, such as the Internet. Thus, server system 130 may comprise multiple computing elements other than request processor 132, video database 134, and account database 136.

Request processor 132 processes (e.g., HTTP) requests from client device 110 for video stored in video database 134. Although depicted as a single element, request processor 132 may also comprise multiple elements and devices.

Video database 134 stores multiple video files, each containing video data. Each video file includes or is associated with zero or more annotations. In response to receiving a request for a video from client device 110, request processor 132 identifies the appropriate video file in video database 134 and, optionally, any annotations that are associated with the video file if such annotations are stored separately, whether in video database 134 or separate from video database 134, such as locally in storage of client device 110.

Account database 136 comprises information about multiples accounts, each corresponding to a different entity, such as an individual user, group of users, or organization (e.g., business or government entity). An account may indicate one or more videos that are associated with the account. The videos may have been requested by the entity of the account or identified (e.g., recommended or shared) by “friends” or social network connections of the entity. Additionally or alternatively, an entity may have registered with or subscribed to a set of videos without individually identifying or requesting the videos in the set. In that case, the accounts stores data that indicates the registration or subscription. Thereafter, an entity (or entity representative) that operates client device 110 may view a listing of videos that have been previously requested by the entity, shared by others, and/or previously subscribed to.

Video and account databases 134-136 may be stored on one or more storage devices (persistent and/or volatile) that may reside within the same local network as server system 130 and/or in a network that is remote relative to server system. Thus, although depicted as being included in server system 130, each storage device may be either (a) part of server system 130 or (b) accessed by server system 130 over a local network, a wide area network, or the Internet.

### Video Player

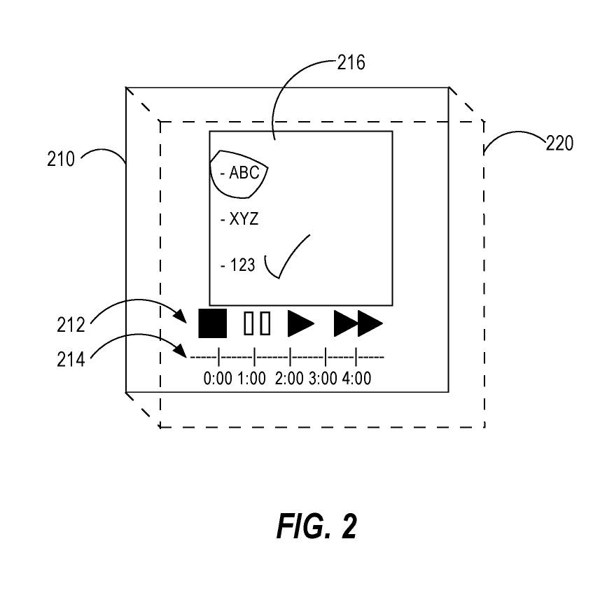

FIG. 2 is a block diagram that depicts example elements provided by video player 112, in an embodiment. Those elements include a window (or display area) 210, video controls 212, a timeline 214, a video display area 216, and an overlay 220. Video player 112 provides its user interface and other data through window 210. Video controls 212 are graphical controls that include a stop button, a pause button, a play button, and a forward button. Timeline 214 indicates where a current playback position is in the corresponding video that is displayed in video display area 216. For example, if three minutes of video playback time have passed from the beginning of the video, then a current location indicator may appear on timeline 214. Alternatively, the value “3:00” may be displayed. Additionally, timeline 214 may indicate the total length (e.g., in minutes and seconds) of the currently selected or loaded video and how much time there is left in playback of the video.

### Overlay

Overlay 220 (indicated by the square of dotted lines) is a transparent element provided by video player 112. A user who is interacting with video player 112 and is viewing video data displayed in video display area 216 does not see overlay 220. Overlay 220 functions as a digital canvas on which a user records data. Thus, a user providing input relative to window 210 may know that some component of the video player is capturing and recording the input.

Data recorded on overlay 220 becomes an “annotation.” An annotation reflects input provided by a user relative to a video while a portion of the video is displayed. An example of user input is a user placing her finger on a touch screen of a mobile device. The user input may also comprise, while her finger is touching the screen, the user moving her finger along the surface of the screen. Video player 112 records the user input on overlay 220. The user input may end when the finger is raised from (or is no longer touching) the screen. Another example of user input is a user moving a (computer) mouse to cause a cursor to move over window 210 and then pressing a button on the mouse. Such user input may also involve moving the mouse while the button is selected or pressed. The user input ends when the user releases the button or, optionally, when the cursor is no longer over any portion of window 210. Another example of user input is voice input that a microphone (associated with client device 110) converts into audio data. The ending of the audio may be triggered by the detection of a certain period of silence and then, afterward, truncating the portion of the audio data that corresponds to that period of silence.

FIG. 2 depicts two annotations: one annotation that is an irregular convex shape that encompasses the text “—ABC” and another annotation that is a check mark that is to the right of the text “—123.” In this example, the text may be part of a slide show presentation that may involve multiple slides in the presentation changing automatically as part of the video, although embodiments are not limited to videos that include slide show presentations. While appearing to be in video display area 216, the irregular convex shape and the check mark are actually on overlay 220. In other words, the annotation does not modify the underlying video data and may be stored separate therefrom.

An annotation may be stored in one of multiple formats. For example, an annotation may be stored as a PNG, TIFF, JPEG, BMP, or GIF image. Alternatively, an annotation may be stored using vector graphics. Vector graphics is the use of geometrical primitives, such as points, lines, and curves to represent images in computer graphics. Vector graphics are based on vectors (also called paths), which lead through locations called control points or nodes. Each control point has a definite position on x and y axes of a work plane (e.g., overlay 220) and determines the direction of a path. Further, each path may be assigned a stroke color, shape, thickness, and fill. Such properties do not substantially increase the size of vector graphics files, as image information resides in the structure of the corresponding document, which describes how the vector should be drawn. Another benefit of vector graphics that a vector graphic can be magnified infinitely without loss of quality, while pixel-based graphics cannot. Thus, the quality of an annotation stored using vector graphics is preserved if the annotation is played back on a larger display (e.g., a 64″ television) than the display (e.g., a touchscreen of a mobile phone) on which the annotation was created.

An annotation may be created while the corresponding video is stopped or while the corresponding video is playing. Thus, a user may first pause video playback and then provide user input. Alternatively, the user may provide user input while the corresponding video is being played and video playback does not pause in response to video player 112 detecting the user input or creating the annotation.

In an embodiment, user input to overlay 220, which causes an annotation to be created, also causes the video (or audio, if player 112 is playing solely audio) to pause or stop. Thus, user input to overlay 220 triggers the pausing of the video. The video may resume in response to subsequent explicit user input (e.g., selecting a graphical play button displayed by the video player), detecting that the user input has ceased (e.g., a user lifts her finger from the screen of the computing device), or the passage of a certain period of time, such as four seconds since receipt of the user input ceased.

In an embodiment, a visual indication of user input is displayed on a screen of client device 110 while the user is providing the input, or in real-time. For example, in FIG. 2, while the user presses and moves her finger over an area (of a touchscreen of client device 110) corresponding to the text “—ABC”, edges of the irregular convex shape are displayed. Alternatively, display of a visual indication is delayed, thus not appearing instantaneously as the input is received. Instead, a visual indication appears later, such as when video player 112 detects that the input has ended (e.g., when the user is no longer touching the touchscreen). A visual indication may be graphical or textual, depending on the type of input.

### Video Display Area

In an embodiment, a window that a video player provides (e.g., generates) (e.g., window 210) includes a video display area (e.g., 216) and a non-video display area. Thus, the video display area and the non-video display area are displayed at the same time. The video display area is where video data is displayed. The non-video display area is where non-video data is displayed. Examples of non-video data include player controls (e.g., 212), a color palette from which the user may select one of many colors and styles, a shape bar from which shapes can be selected for insertion onto overlay 220, a text bar from which font styles, sizes, and colors may be selected for insertion onto overlay 220, text where one or more descriptions related to the content of the video is displayed. In this embodiment, overlay 220 is available “over” the video display area only. Thus, any input that is received on the non-video display area does not trigger the creation of an annotation.

In a related embodiment, non-video data may be dynamically displayed in a non-video display area while a video is being played. An example of such non-video data is text comments that are stored in association with certain times in the video. Based on the current playback position of the video, certain text comments are selected for display. In this embodiment, overlay 220 covers (at least a portion of) the non-video display area in addition to the video display area. Therefore, annotations may be created based on detecting user input relative to the non-video display area.

### Annotation Mode

In an embodiment, video player 112 has at least two modes: an annotation mode and a non-annotation mode. In annotation mode, video player 112 provides overlay 220 through which a user may cause annotations to be created. In non-annotation mode, video player 112 does not provide overlay 220. Thus, while in non-annotation mode, user input applied to display area 216 does not cause an annotation to be created.

Annotation mode may be switched on or off through any mechanism, such as a drop down menu (not depicted) available at the top of window 210 or a graphical toggle or button that is displayed outside, but adjacent to, display area 216.

### Time Data for an Annotation

In an embodiment, an annotation is associated with a particular time or time period relative to a video. The particular time may be the time that the user input was initially received, where the time is a time within the video, such as at 4:32 from the beginning of the video. Alternatively, the particular time may be the time (e.g., relative to the beginning or ending of the video) when the user input ceased, such as when the user lifted her finger such that the finger no longer touches the screen of the mobile device.

If an annotation is associated with a time period, then the time period may begin when the user input began and end when the user input ended. For example, at time 3:12 in a video, a user pressed a mouse button while a cursor was displayed over a portion of the video. Between times 3:12 and 3:24 in the video, the user provided continuous input by moving the cursor with the mouse while pressing the mouse button. Moving the mouse with the button pressed causes a red line to appear wherever the cursor traverses. At time 3:24 in the video, the user released the mouse button. In this example, the time range of 3:12-3:24 is recorded along with the annotation (indicating locations on the screen the cursor was located while the mouse button was pressed).

In an embodiment, when providing user input, overlay 220 may display different content in response to receiving user input depending on current settings, some of which may be default settings. Examples of settings include line style, thickness, and color if the user input is a finger on a touchscreen or if the user input is moving a mouse. Other examples of settings include font size and color (if the user input is text), shape size and color (if the user input is inserting a shape, such as square, oval, or pentagon).

### Section Data for an Annotation

In a related embodiment, an annotation is associated with a section of video instead of, or in addition to, a particular time within the video. In this embodiment, a video is divided into sections, which may or may not be uniform in length of time. An example of a sectioned video is one where the video includes a slide presentation and each slide is displayed for a certain period of time, which is recorded in the corresponding video file or in a record or file (or “metadata”) that is associated with the video file. The amount of time that each slide is displayed may vary. A user may have originally established the sections, such as with markers when composing the video, or the sections may have been created automatically based on an automatic analysis of the video, such as significant differences between video frames.

In a related embodiment, instead of an entire section, an annotation is associated with the most recent (e.g., slide) marker or start time of a section. For example, if markers are at video times 2:33, 4:56, and 8:13 and an annotation is created at (or began to be created at) video time 7:54, then the annotation is associated with the marker at video time 4:56.

In an embodiment, playback of a video automatically stops in response to detecting that user input was received during one section of the video and has not ceased (e.g., by lifting up the user's finger from the screen) when the section ended. For example, a user intends to circle a number in a video of a slide presentation. While the number is displayed on a slide, the user begins to make a circle figure with her finger pressed to a screen of client device 110. Before the user completes the circle, the time for switching the slide with a subsequent slide has arrived. However, instead of displaying the new slide, video player 112 pauses playback of the video. Therefore, the video may resume automatically when the user input ceases (e.g., by the user lifting her finger from the screen). Alternatively, the user provides explicit input to resume playback of the video, such as selecting a play button in controls 212.

### Example Process

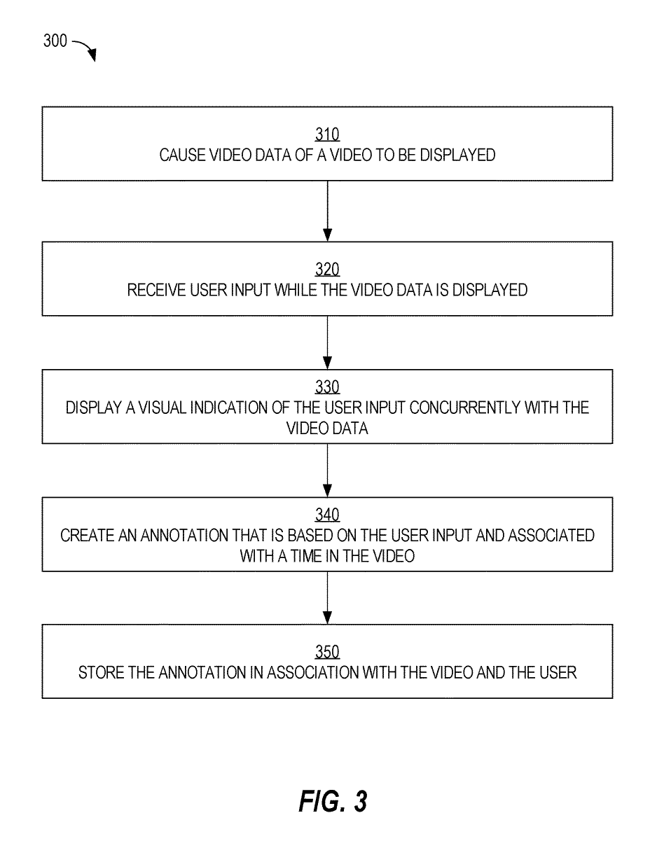

FIG. 3 is a flow diagram that depicts a process 300 for creating an annotation to video data, in an embodiment. Process 300 may be implemented by video player 112.

At block 310, a video is played, causing video data to be displayed on a screen of client device 110. The video may be played in response to user selection of a graphical item that represents the video. At the time of selection, the video may be stored locally on client device 110 or in video database 134 of server system 130, in which case the selection initiates a request to be sent over network 120 to server system 130, where the request include video identification data that identifies the video. In response, request processor 132 uses the video identification data to retrieve one or more video files from video database 134 and send the one or more video files to client device 110.

At block 320, while video data is displayed on the screen of client device 110, user input is received. As noted previously, examples of user input include the user (a) touching a touchscreen of client device 110, (b) moving a cursor that is displayed on the screen of client device 110 by moving a computer mouse, (c) selecting a physical or graphical key of a keyboard, or (d) providing voice instructions.

At block 330, a visual indication of the user input is displayed concurrently with the video data. Playback of the video may pause while the visual indication is displayed or while the input is received. Alternatively, playback of the video may continue while the visual indication is displayed. The visual indication may vary depending on the type of user input, such as a red line that forms wherever the user drags her finger along the touchscreen or alphanumeric characters (in response to voice input or in response to keyboard selections) appearing where a cursor is currently located on the screen. The visual indication is recorded on overlay 220, which is transparent to the user other than the visual indication.

At block 340, the visual indication is recorded as an annotation and associated with a point in time in the video.

At block 350, the annotation is stored in association with the video and, optionally, with the user that provided the user input.

### Presenting an Annotation while Displaying Video

In an embodiment, an annotation that is stored in memory of client device 110 is identified and presented through (e.g., displayed on a screen of) client device 110. A determination of whether to present the annotation is based, at least in part, on whether a current time in a timeline of video that is playing is the same as or close to (e.g., within a certain threshold time) a time associated with the annotation. Thus, multiple comparisons may be made between the current time in the timeline and the time associated with the annotation before the annotation is presented. In response to the affirmative, the annotation is presented.

In an embodiment, an annotation is displayed for a certain period of time before or after the time associated with the annotation has passed. This may be used if the annotation is only associated with a single time (that is relative to the beginning or ending of the video). For example, a default display period may be three seconds, which is enough time for a user viewing the accompanying video to see and appreciate the annotation or the video information to which the annotation is intended to draw the viewer's gaze. As another example, if an annotation is associated with a time period, then the annotation is only displayed during the time period.

As another example, a video player detects when an event occurs and ceases to display an annotation in response to the detection. As a specific example, a video may include a slide presentation about which a person (e.g., an author of the slides) is speaking. Each slide is associated with a time period of when the slide is displayed. The video player determines when a slide is no longer being displayed. If an annotation is association with a particular slide, then the annotation may be displayed during the entire time the particular slide is displayed (e.g., regardless of whether the annotation is associated with (or created at) a time that is later than the time corresponding to the beginning of the slide or earlier than the time corresponding to the end of the slide) and, as soon as the particular slide is no longer displayed (such as when a subsequent slide is displayed in place of the particular slide), the annotation also ceases to be displayed.

In an embodiment, video player 112 displays a list indicating multiple annotations that were created for a video. The list may identify annotations that were created by (1) the user of client device 110 or client device 110 (regardless of who operated client device 110 at the time the annotation was created) and/or (2) another user of another client device. The list may be displayed when the corresponding video is loaded or has been selected for viewing. Alternatively, the list may be displayed when a user requests to see annotations that are associated with the user. For example, the user provides input to video player 112 to view annotations, video player 112 generates and sends an annotation view request over network 120 to server system 130, request processor 132 identifies annotations that are associated with the user (e.g., by looking up, in account database 136) an account that is associated with the user, and returns the annotations (or just annotation indicators) to client device 110, which displays a list of annotation indicators in response to receipt thereof.

Each annotation indicator in the list may one or more multiple information items, such as a time associated with the corresponding annotation, a time period associated with the corresponding annotation, a type of annotation (e.g., graphic, text, lines, shapes, audio, etc.), and a video indicator that indicates which video to which the annotation is associated. A video indicator is useful if the annotation list is not necessarily associated with a particular video, such as a list of all annotations associated with the user, another user, a user group, or an organization.

Selection of an identified annotation in the list may cause video player 112 to display the annotation (e.g., in video display area 216) in addition to the video data at a time corresponding to the annotation. For example, an annotation is associated with time 3:23 in a video. User selection of an annotation indicator causes the corresponding video to be loaded (if not already loaded) and displayed beginning at a time just prior to the time associated with the annotation, such as time 3:20 in this example. In this way, a user may view an annotation without having to view all video data that precedes the time associated with the annotation.

In an embodiment, a displayed timeline (e.g., timeline 214) of a particular video is updated to include annotation indicators. The location of an annotation indicator in the timeline is determined by the time (or time period) associated with the annotation. Thus, if an annotation is associated with time 0:43 in a particular video, then an annotation indicator appears at a location in the timeline that corresponds to time 0:43. Selection of the annotation indicator may cause playback of the particular video to occur at time 0:43 (along with presentation of the corresponding annotation) or at a time prior to 0:43, such as 0:38. Alternatively, instead of initiating playback, selection of an annotation indicator may cause a frame (in the particular video) that corresponds to time 0:43 to be displayed along with the corresponding annotation.

### Multiple Snapshots

In an embodiment, multiple “snapshots” of user input over a period of time are captured on overlay 220. Thus, a group of snapshots corresponds to a single instance of user input, where the user input has a time duration that is greater than 0. An example of such user input is when a user drags her finger across a touchscreen of a tablet computer. If a user selects a single key from a graphical keyboard, which selection causes a single character or image to be applied to overlay 220, then no group of snapshots is taken. However, if the user selects multiple keys (e.g., the user typing a word, phrase, or sentence), then the entire sequence of user selections may be considered a single instance of user input and a snapshot is created after each key stroke.

Regardless of how a group of snapshot is formed, at least one snapshot (e.g., the first snapshot in the group) corresponds to a time period in which user input is received, where the time period is less than the entire time period in which the user input is received. For example, a first snapshot is taken when a user ends the down-stroke of the check mark in FIG. 2 (and pauses or changes direction) and a second snapshot is taken when the user input ends (e.g., the user lifts her finger from a touchscreen of the client device). The latter snapshot includes the down-stroke of the check mark. Each snapshot is stored separately as an annotation as, for example, a pixel-based image or a vector-based image. Later, when the annotations are displayed, the first annotation is displayed at the appropriate time and the second annotation is displayed soon thereafter. The second annotation effectively replaces the first annotation since the second annotation contains all the user input recorded in the first annotation.

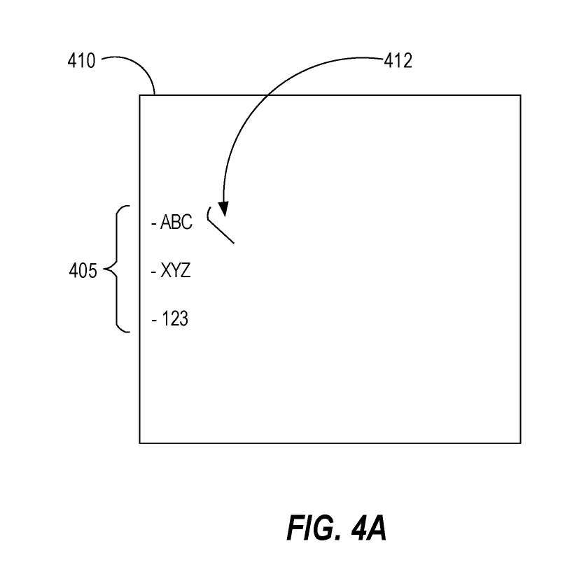

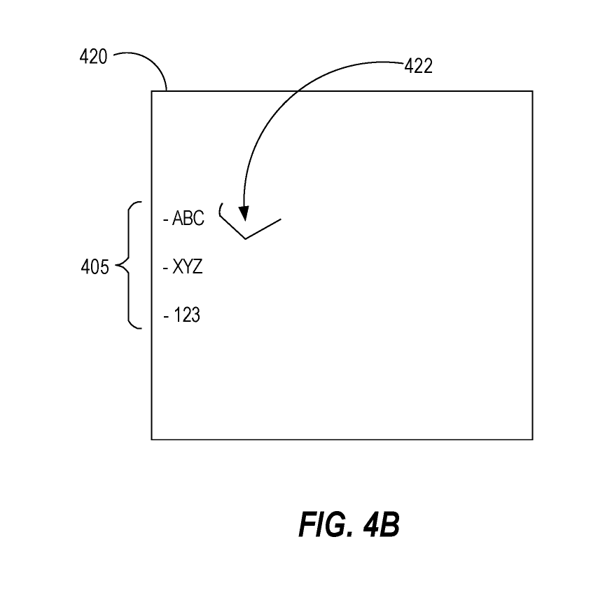

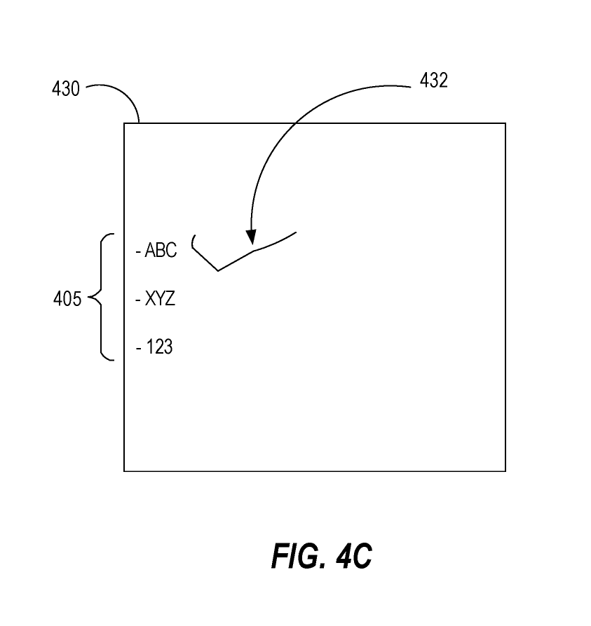

FIGS. 4A-4C are block diagrams that depict multiple snapshots of user input, in an embodiment. Each of FIGS. 4A-4C depicts video content 405. A video player generates each of snapshots 410-430 (e.g., of an overlay on which user input is received) in response to receiving user input. FIG. 4A depicts snapshot 410 that is created at time A within a video timeline and that indicates user input 412. FIG. 4B depicts snapshot 420 that is created at time B within the video timeline and that indicates user input 422. FIG. 4C depicts a snapshot 430 that is created at time C within the video timeline and that indicates user input 432, where time B is after time A, and time C is after time B. As FIGS. 4A-4C depict, the recorded user input appears longer (or more complete) on each subsequent snapshot relative to a previous snapshot that is generated in response to receiving and detecting the user input.

By taking multiple snapshots (or creating multiple annotations) for a single user input and replaying the annotations later, an effect is that it appears as if the text or graphics are occurring at the same rate and speed as the original user input. Snapshots may be taken every second, half a second, millisecond, etc. The number of snapshots taken may adjust dynamically based on one or more factors, such as the current memory resources of client device 110, the current availability of one or more CPUs of client device 110, current network bandwidth, the size of each snapshot, and/or the size of the corresponding video in addition to the created annotations thus far.

In an embodiment, video player 112 allows a user to adjust how many or how often snapshots are generated. For example, the user may select one snapshot per second, two snapshots per second, or one snapshot per frame. Thus, if the frame rate is 24 frames per second, then 24 snapshots (and, therefore, 24 annotations) are created per second, assuming that the duration of the user input lasts that long. Example user interface controls that video player 112 may provide to adjust the number of snapshots include a drop down menu, multiple radio buttons each corresponding to a different snapshot creation frequency, or a graphical dial. In a related embodiment, if a group of two or more snapshots are considered to be the same or nearly identical (e.g., greater than 95% similarity or greater than 90% across a certain period of time, like 1 second), then all but one of the snapshots are discarded and only one annotation is generated for the group. The last snapshot in the group (which snapshot should reflect the most change from the most recent snapshot prior to the group of snapshots) may be selected for generating the annotation.

### Storing Annotations

In an embodiment, an annotation is stored in volatile or non-volatile storage (of client device 110) upon its creation. The annotation may be stored on client device 110 indefinitely. Alternatively, an annotation may be cached locally until client device 110 establishes a connection with server system 130, which may be responsible for persistently storing annotations created by client device 110 on behalf of the user of client device 110.

Thus, in an embodiment, an annotation is transferred from client device 110 over network 120 to server system 130. The transfer may occur automatically or in response to explicit user input to store or transfer annotations. For example, video player 112 presents a dialog box that asks the user whether she would like to save the annotations that were created in response to input she provided relative to a particular video. As another example, video player 112 transfers an annotation to server system 130 upon a determination that a connection has been established between client device 110 and server system 130.

In one approach, a transferred annotation is stored in an account of the user of client device 110, if the user is already logged into server system 130. If not, then the user may need to provide credentials (e.g., a username and password) before storing an annotation in her account. The account may be for just that user, a group of users that includes the user, or an organization that includes the user. Later, the user may request to view the same video again. Thus, client device 110 (or, more specifically, video player 112 or another application executing on client device 110) sends a request over network 120 to server system 130, where the request includes video identification data and/or account identification data. Request processor 132 uses the video identification data to retrieve the appropriate video file(s) from video database 134. Request processor 132 may first verify that the user is authorized to view the video by checking an account of the user (stored in account database 136) based on the account identification data. Request processor 132 also checks account database 136 to determine whether there are any annotations associated with the requested video and the user.

In an alternative approach to checking account database 136 for annotations associated with a requesting user, each annotation is associated with a different list of authorized entities, such as users, groups, or other types of entities. Thus, a requested video is identified and annotations associated with the requested video are identified. Then, entity identification data associated with the requesting user is used to traverse the list of authorized entities of each annotation.

In either approach, while different users may request to view the same video and the same video is associated with one or more annotations, each user may have access to a different set of the annotations or none at all.

### Sharing Annotations

In an embodiment, a user of client device 110 is allowed to share an annotation with one or more other users. Thus, the client device upon which the annotation is eventually displayed may be different than the client device upon which the annotation was created. The user may specify or otherwise indicate the one or more users and provide additional input to cause the annotation to be associated with the one or more users.

For example, video player 112 (or an application in which video player 112 is embedded) sends an annotation and an identification of the one or more users to server system 130 over network 120. Request processor 132 identifies the type of request (i.e., a sharing request) and stores the received annotation in association with (or in) each account that is associated with one of the identified users. Additionally or alternatively, server system 130 immediately sends the annotation to each of the identified users. Whether server system 130 sends the annotation immediately to the identified users may depend on determining whether client devices of the identified users are currently connected to server system 130. A notification may first be sent to those client devices indicating that an annotation is available; thus, requiring the identified users to provide input to receive the annotation and present the annotation concurrently with the corresponding video.

### Localization

In an embodiment, a content creator or author of a video creates multiple versions of an annotation for the video, where each version corresponds to a different language. For example, a video author creates an English version of an annotation and a Spanish version of the annotation. The annotation may include data (e.g., graphics) that is not translatable and that is common to both versions. Video player 112 or server system 130 determines which version of an annotation to present to a user of client device 110. For example, video player 112 receives multiple language-specific versions of an annotation from server system 130 and video player 112 is responsible for making the determination. As another example, server system 130 determines which language-specific version and sends the appropriate language-specific version to video player 112.

The determination may be based on IP address of client device 110 (which IP address may be mapped to a particular country or geographic region), residence information stored in an account of the user (stored in account database 138), or locale settings stored on client device 110. The determination may be made in response to receiving, from client device 110, at request processor 132, a request for a particular video.

If the determination is that the user of client device 110 is likely an English speaker, then video player 112 presents a set of English language annotations. If the determination is that the user is likely a Spanish speaker, then video player 112 presents a set of Spanish language annotations. In both cases, the video player 112 may first receive the set of language-specific annotations from server system 130.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

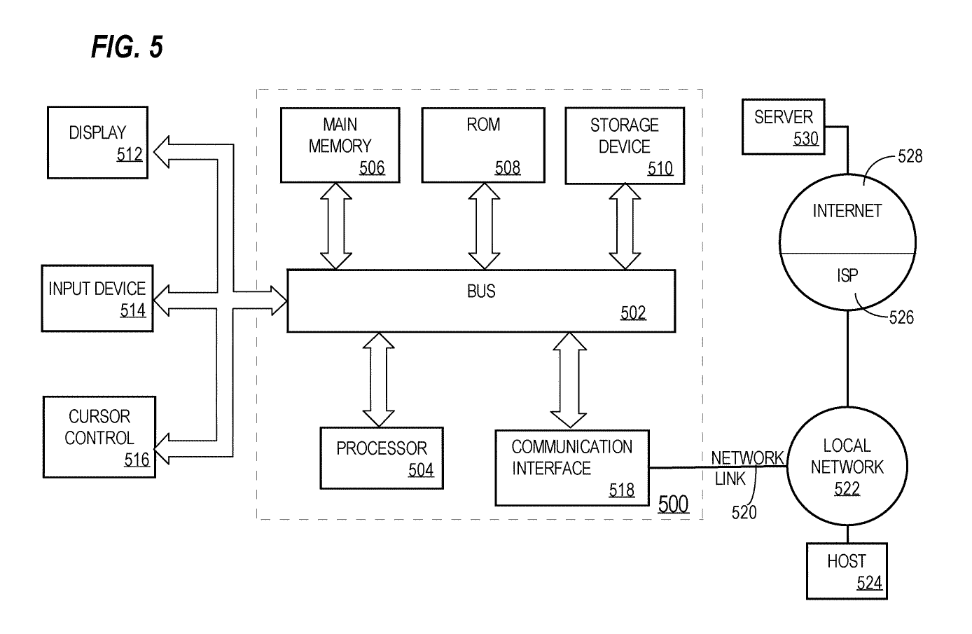

For example, FIG. 5 is a block diagram that illustrates a computer system 500 upon which an embodiment of the invention may be implemented. Computer system 500 includes a bus 502 or other communication mechanism for communicating information, and a hardware processor 504 coupled with bus 502 for processing information. Hardware processor 504 may be, for example, a general purpose microprocessor.

Computer system 500 also includes a main memory 506, such as a random access memory (RAM) or other dynamic storage device, coupled to bus 502 for storing information and instructions to be executed by processor 504. Main memory 506 also may be used for storing temporary variables or other intermediate information during execution of instructions to be executed by processor 504. Such instructions, when stored in non-transitory storage media accessible to processor 504, render computer system 500 into a special-purpose machine that is customized to perform the operations specified in the instructions.

Computer system 500 further includes a read only memory (ROM) 508 or other static storage device coupled to bus 502 for storing static information and instructions for processor 504. A storage device 510, such as a magnetic disk or optical disk, is provided and coupled to bus 502 for storing information and instructions.

Computer system 500 may be coupled via bus 502 to a display 512, such as a cathode ray tube (CRT), for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane.

Computer system 500 may implement the techniques described herein using customized hard-wired logic, one or more ASICs or FPGAs, firmware and/or program logic which in combination with the computer system causes or programs computer system 500 to be a special-purpose machine. According to one embodiment, the techniques herein are performed by computer system 500 in response to processor 504 executing one or more sequences of one or more instructions contained in main memory 506. Such instructions may be read into main memory 506 from another storage medium, such as storage device 510. Execution of the sequences of instructions contained in main memory 506 causes processor 504 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage device 510. Volatile media includes dynamic memory, such as main memory 506. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 502. Transmission media can also take the form of acoustic or light waves, such as those generated during radio-wave and infra-red data communications.

Various forms of media may be involved in carrying one or more sequences of one or more instructions to processor 504 for execution. For example, the instructions may initially be carried on a magnetic disk or solid state drive of a remote computer. The remote computer can load the instructions into its dynamic memory and send the instructions over a telephone line using a modem. A modem local to computer system 500 can receive the data on the telephone line and use an infra-red transmitter to convert the data to an infra-red signal. An infra-red detector can receive the data carried in the infra-red signal and appropriate circuitry can place the data on bus 502. Bus 502 carries the data to main memory 506, from which processor 504 retrieves and executes the instructions. The instructions received by main memory 506 may optionally be stored on storage device 510 either before or after execution by processor 504.

Computer system 500 also includes a communication interface 518 coupled to bus 502. Communication interface 518 provides a two-way data communication coupling to a network link 520 that is connected to a local network 522. For example, communication interface 518 may be an integrated services digital network (ISDN) card, cable modem, satellite modem, or a modem to provide a data communication connection to a corresponding type of telephone line. As another example, communication interface 518 may be a local area network (LAN) card to provide a data communication connection to a compatible LAN. Wireless links may also be implemented. In any such implementation, communication interface 518 sends and receives electrical, electromagnetic or optical signals that carry digital data streams representing various types of information.

Network link 520 typically provides data communication through one or more networks to other data devices. For example, network link 520 may provide a connection through local network 522 to a host computer 524 or to data equipment operated by an Internet Service Provider (ISP) 526. ISP 526 in turn provides data communication services through the world wide packet data communication network now commonly referred to as the “Internet” 528. Local network 522 and Internet 528 both use electrical, electromagnetic or optical signals that carry digital data streams. The signals through the various networks and the signals on network link 520 and through communication interface 518, which carry the digital data to and from computer system 500, are example forms of transmission media.

Computer system 500 can send messages and receive data, including program code, through the network(s), network link 520 and communication interface 518. In the Internet example, a server 530 might transmit a requested code for an application program through Internet 528, ISP 526, local network 522 and communication interface 518.

The received code may be executed by processor 504 as it is received, and/or stored in storage device 510, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
while a video is being played by a video player application on a portion of a screen of a computing device:
receiving user input on the portion of the screen, wherein the user input corresponds to, in the video, a period of time that includes a first time and a second time that is after the first time;
while receiving the user input:
generating a first snapshot, of the user input, that corresponds to the first time;
creating, based on the first snapshot, a first annotation that identifies the first time;
storing the first annotation in association with the video;
generating a second snapshot, of the user input, that corresponds to the second time;
creating, based on the second snapshot, a second annotation that identifies the second time;
storing the second annotation in association with the video.

2. The method of claim 1, further comprising:
sending, over a network, from the computing device, the first annotation and video identification data that identifies the video.

3. The method of claim 1, further comprising, after storing the first annotation in association with the video:
while a second video player application is playing the video:
determining a current time that is relative to the beginning of the video;
performing a comparison between the current time and the first time;
based on the comparison, causing the first annotation to be displayed on a screen of a second computing device.

4. The method of claim 3, wherein the computing device is a first computing device that is different than the second computing device.

5. The method of claim 3, further comprising:
generating time data that identifies a plurality of times that includes the first time and a third time that is after the first time;
wherein causing the first annotation to be displayed comprises causing the first annotation to be displayed for a time range indicated by the first time and the third time.

6. The method of claim 1, further comprising:
receiving, over a network, a third annotation that is different than the first annotation and the second annotation and that is associated with a third time and a second video;
while the second video is being played by the video player application:
determining a current time that is relative to the beginning of the second video;
performing a comparison between the current time and the third time;
based on the comparison, causing the third annotation to be displayed on the screen of the computing device.

7. The method of claim 1, further comprising, in response to receiving the user input:
identifying a particular section among a plurality of pre-defined sections in the video, wherein frames from the particular section are displayed when the user input is received;
storing, in association with the first annotation, section data that identifies the particular section.

8. The method of claim 7, further comprising, after storing the first annotation in association with the video:
while the video player application is playing the video and displaying the first annotation:
determining whether video data from the particular section is being displayed;
in response to determining that video data from the particular section is no longer being displayed, removing the first annotation from the screen of the computing device.

9. The method of claim 7, wherein:
each section of the plurality of pre-defined sections corresponds to a slide in a slideshow presentation in the video data;
at least two sections in the plurality of pre-defined sections have different time durations during normal playback of the video.

10. A system comprising:
one or more processors;
one or more computer-readable media storing instructions which, when executed by the one or more processors, cause:
while a video is being played by a video player application on a portion of a screen of a computing device:
receiving user input on the portion of the screen, wherein the user input corresponds to, in the video, a period of time that includes a first time and a second time that is after the first time;
while receiving the user input:
generating a first snapshot, of the user input, that corresponds to the first time;
creating, based on the first snapshot, a first annotation that identifies the first time;
storing the first annotation in association with the video;
generating a second snapshot, of the user input, that corresponds to the second time;
creating, based on the second snapshot, a second annotation that identifies the second time;
storing the second annotation in association with the video.

11. The system of claim 10, wherein the instructions, when executed by the one or more processors, further cause:
sending, over a network, from the computing device, the first annotation and video identification data that identifies the video.

12. The system of claim 10, wherein the instructions, when executed by the one or more processors, further cause, after storing the first annotation in association with the video:
while a second video player application is playing the video:
determining a current time that is relative to the beginning of the video;
performing a comparison between the current time and the first time;
based on the comparison, causing the first annotation to be displayed on a screen of a second computing device.

13. The system of claim 12, wherein the computing device is a first computing device that is different than the second computing device.

14. The system of claim 12, wherein the instructions, when executed by the one or more processors, further cause:
generating time data that identifies a plurality of times that includes the first time and a third time that is after the first time;
wherein causing the first annotation to be displayed comprises causing the first annotation to be displayed for a time range indicated by the first time and the third time.

15. The method of claim 10, wherein the instructions, when executed by the one or more processors, further cause:
receiving, over a network, a third annotation that is different than the first annotation and the second annotation and that is associated with a third time and a second video;
while the second video is being played by the video player application:
determining a current time that is relative to the beginning of the second video;
performing a comparison between the current time and the third time;
based on the comparison, causing the third annotation to be displayed on the screen of the computing device.

16. The system of claim 10, wherein the instructions, when executed by the one or more processors, further cause, in response to receiving the user input:
identifying a particular section among a plurality of pre-defined sections in the video, wherein frames from the particular section are displayed when the user input is received;
storing, in association with the first annotation, section data that identifies the particular section.

17. The system of claim 16, wherein the instructions, when executed by the one or more processors, further cause, after storing the first annotation in association with the video:
while the video player application is playing the video and displaying the first annotation:
determining whether video data from the particular section is being displayed;
in response to determining that video data from the particular section is no longer being displayed, removing the first annotation from the screen of the computing device.

18. The system of claim 16, wherein:
each section of the plurality of pre-defined sections corresponds to a slide in a slideshow presentation in the video data;
at least two sections in the plurality of pre-defined sections have different time durations during normal playback of the video.
